(19) United States
(12) Patent Application Publication
(10) Pub. No.: US 2026/0156149 A1
(43) Pub. Date: Jun. 4, 2026

(54) E-MAIL ADD-ON FOR EVALUATING E-MAILS AS POTENTIAL PHISHING ATTACKS

(71) Applicant: PULSAR SECURITY, LLC, Derry, NH (US)

(72) Inventors: Patrick Joseph Hynds, Derry, NH (US); Duane Leo Laflotte, Merrimack, NH (US)

(21) Appl. No.: 19/267,013

(22) Filed: Jul. 11, 2025

Related U.S. Application Data
(60) Provisional application No. 63/670,366, filed on Jul. 12, 2024.

(51) Int. Cl. H04L 9/40; G06Q 10/107; H04L 51/18

(52) U.S. Cl. CPC H04L 63/1483; G06Q 10/107; H04L 51/18; H04L 63/1433

(57) ABSTRACT

Aspects and embodiments disclosed herein include a computerized platform for providing a user with an indication of one of a risk level or a probability of an e-mail including a phishing attack. The computerized platform is configured to perform a method comprising performing an assessment of one or more characteristics of one or more aspects of the e-mail, determining the one of the risk level or the probability of the e-mail including a phishing attack based on results of the assessment, and providing the user with the indication of the one of the risk level or the probability of the e-mail including the phishing attack.

### CROSS-REFERENCE TO RELATED APPLICATIONS

This application claims priority under 35 U.S.C. § 119(e) to U.S. Provisional Patent Application Ser. No. 63/670,366, titled “E-MAIL ADD-ON FOR EVALUATING E-MAILS AS POTENTIAL PHISHING ATTACKS” filed Jul. 12, 2024, the entire content of which is incorporated herein by reference for all purposes.

### FIELD OF TECHNOLOGY

Aspects and embodiments disclosed herein are generally directed to an add-on to electronic mail systems that evaluates e-mails as potential phishing attacks and provides an indication of the risk level of an e-mail to a user.

### SUMMARY

In accordance with one aspect, there is provided a computerized platform for providing a user with an indication of one of a risk level or a probability of an e-mail including a phishing attack. The computerized platform is configured to perform a method comprising performing an assessment of one or more characteristics of one or more aspects of the e-mail, determining the one of the risk level or the probability of the e-mail including a phishing attack based on results of the assessment, and providing the user with the indication of the one of the risk level or the probability of the e-mail including the phishing attack.

In some embodiments, the computerized platform is configured to produce a graphical display including the indication of the one of the risk level or the probability of the e-mail including the phishing attack.

In some embodiments, the computerized platform is further configured to provide an indication of one or more factors contributing to the one of the risk level or the probability of the e-mail including the phishing attack within the graphical display.

In some embodiments, the one or more aspects include one or more of a source of the e-mail, spoof potential of the e-mail, a link within the e-mail, an attachment to the e-mail, or content of the e-mail.

In some embodiments, the one or more characteristics of the source of the e-mail include one or more of whether a domain of the source of the e-mail is trusted, whether the domain of the source of the e-mail is DMARC, SPF, or DKIM enabled, whether a top level domain of the source of the e-mail is trusted, whether the top level domain of the source of the e-mail is dangerous, or an age of the domain of the source of the e-mail.

In some embodiments, the one or more characteristics of the source of the e-mail include whether the user has had prior contact with the source of the e-mail.

In some embodiments, the one or more characteristics of the source of the e-mail include whether a Reply To address of the email matches the source of the e-mail.

In some embodiments, the one or more characteristics of the link within the e-mail include one or more of whether the link is clear and direct, whether the link is a shortened link, or whether the link is misleading.

In some embodiments, the one or more characteristics of the attachment to the e-mail include one or more of whether a file extension of the attachment is considered dangerous or whether the attachment has a file extension that is consistent with its context.

In some embodiments, the one or more characteristics of the content of the e-mail include one or more of whether the e-mail includes a prompt of urgency, whether the e-mail includes spelling or grammar mistakes, or whether the e-mail appears suspicious to the user.

In accordance with another aspect, there is provided a method for providing a user with an indication of one of a risk level or a probability of an e-mail including a phishing attack. The method comprises performing an assessment of one or more characteristics of one or more aspects of the e-mail, determining the one of the risk level or the probability of the e-mail including a phishing attack based on results of the assessment, and providing the user with the indication of the one of the risk level or the probability of the e-mail including the phishing attack.

In some embodiments, the method further comprises producing a graphical display including the indication of the one of the risk level or the probability of the e-mail including the phishing attack.

In some embodiments, the method further comprises providing an indication of one or more factors contributing to the one of the risk level or the probability of the e-mail including the phishing attack within the graphical display.

In some embodiments, the one or more aspects include one or more of a source of the e-mail, spoof potential of the e-mail, a link within the e-mail, an attachment to the e-mail, or content of the e-mail.

In some embodiments, the one or more characteristics of the source of the e-mail include one or more of whether a domain of the source of the e-mail is trusted, whether the domain of the source of the e-mail is DMARC, SPF, or DKIM enabled, whether a top level domain of the source of the e-mail is trusted, whether the top level domain of the source of the e-mail is dangerous, or an age of the domain of the source of the e-mail.

In some embodiments, the one or more characteristics of the source of the e-mail include whether the user has had prior contact with the source of the e-mail.

In some embodiments, the one or more characteristics of the source of the e-mail include whether a Reply To address of the email matches the source of the e-mail.

In some embodiments, the one or more characteristics of the link within the e-mail include one or more of whether the link is clear and direct, whether the link is a shortened link, or whether the link is misleading.

In some embodiments, the one or more characteristics of the attachment to the e-mail include one or more of whether a file extension of the attachment is considered dangerous or whether the attachment has a file extension that is consistent with its context.

In some embodiments, the one or more characteristics of the content of the e-mail include one or more of whether the e-mail includes a prompt of urgency, whether the e-mail includes spelling or grammar mistakes, or whether the e-mail appears suspicious to the user.

In accordance with another aspect, there is provided a non-transitory computer readable medium having instructions encoded thereon which when executed by a processing system of computer causes the processing system to perform a method for providing a user with an indication of one of a risk level or a probability of an e-mail including a phishing attack. The method comprises performing an assessment of one or more characteristics of one or more aspects of the e-mail, determining the one of the risk level or the probability of the e-mail including a phishing attack based on results of the assessment, and providing the user with the indication of the one of the risk level or the probability of the e-mail including the phishing attack.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of any particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a flow chart of an example of an e-mail phishing risk evaluation method;

FIG. 2 is an example of a display of results of the e-mail phishing risk evaluation method of FIG. 1;

FIG. 3 is a flow chart of examples of characteristics related to the source of an e-mail that embodiments of the phishing security add-on system may evaluate and example point scores associated with these characteristics;

FIG. 4 is a flow chart of examples of characteristics related to links in an e-mail that embodiments of the phishing security add-on system may evaluate and example point scores associated with these characteristics;

FIG. 5 is a flow chart of examples of characteristics related to attachments to an e-mail that embodiments of the phishing security add-on system may evaluate and example point scores associated with these characteristics;

FIG. 6 is a flow chart of examples of characteristics related to the content of an e-mail that embodiments of the phishing security add-on system may evaluate and example point scores associated with these characteristics; and

FIG. 7 is a block diagram of one example of a computer system with which various aspects in accord with the present disclosure may be implemented.

### DETAILED DESCRIPTION

Malware delivered through e-mail to user's personal or work e-mail accounts is an ever increasing problem. According to certain industry estimates, as of 2023, over 1% of all e-mails sent are malicious, with over 3.4 billion phishing e-mails sent every day. According to Verizon's Data Breach Report, Phishing attacks are involved in 36% of all data breaches. The FBI reports that 83% of all companies experienced phishing attacks in 2021. There can be no doubt that phishing is a scourge online today affecting each and every individual who operates an e-mail address and a computer. Individuals who do not understand how to identify an e-mail as potentially malicious may unknowingly or unintentionally allow a malicious actor to release a ransomware or phishing attack by, for example, clicking on a link in a malicious e-mail or by simply responding to the malicious e-mail. A ransomware attack could subject an individual or their company to a loss of access to valuable data unless a ransom is paid to the actor responsible for the ransomware attack, often with no guarantee that the malicious actor will restore access to the data if the ransom is paid. A phishing attack could allow for the malicious actor to access personal or other confidential data from a user's personal or business computer or network which may be used to perpetrate further fraud such as identity theft, impersonating an individual to apply for credit cards or tax refunds in their name, or to perform other fraudulent or malicious activities.

A need thus exists for a tool that can help users evaluate e-mails as potential phishing attacks.

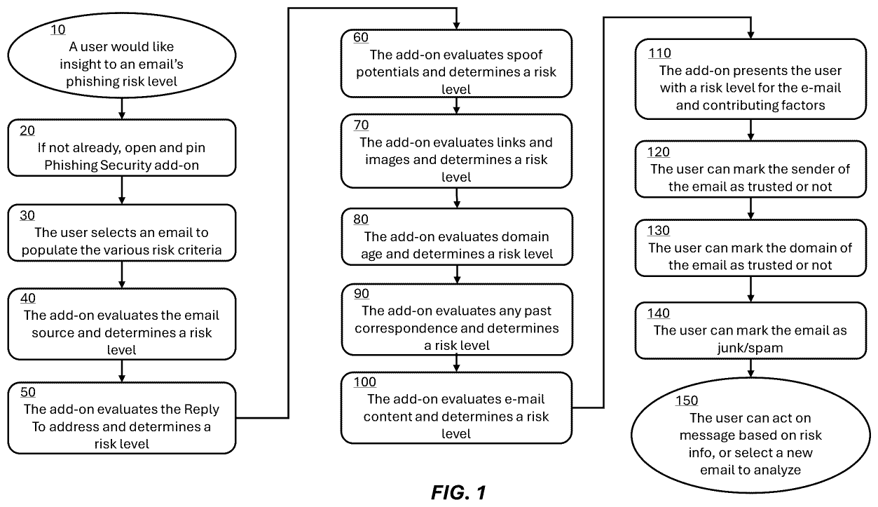

A high level flow chart of an e-mail phishing risk evaluation method in accordance with aspects and embodiments of the present disclosure is illustrated in FIG. 1. At act 10, a user determines that they would like an e-mail evaluated for risk of being a phishing attack. At act 20 the user opens the phishing security add-on if it is not already open. Some e-mail clients, for example, the Microsoft® e-mail client support add-ons that can be opened. It is built into the e-mail client as an extra tab but it needs to be pinned in place to stay open when selection of a new email changes. At act 30 the user selects a particular e-mail that they would like evaluated for risk of being a phishing attack, for example, by clicking on the e-mail or opening it. The phishing security add-on then performs a series of checks of different aspects of the e-mail and determines if these aspects exhibit characteristics that are consistent or inconsistent with phishing attacks. If an aspect of the e-mail exhibits characteristics that are consistent with a phishing attack the phishing security add-on assigns point scores to the suspicious aspects and adds point scores for each suspicious aspect to generate a cumulate risk point score for the e-mail which is used later in the method to generate an overall phishing attack risk score and/or probability of the e-mail being a phishing attack. The overall phishing attack risk score and/or probability of the e-mail being a phishing attack may be displayed to a user along with an explanation of what aspects of the e-mail exhibited signs of a possible phishing attack so the user has the opportunity to decide if the phishing security add-on is accurately detecting suspicious aspects of the e-mail or if it is generating a false alarm. Characteristics of aspects of an e-mail that may be considered suspicious and indicative of a possible phishing attack are described in more detail below. Aspects of an e-mail that the phishing security add-on may evaluate for indicia of a possible phishing attack may include, for example, the source of the e-mail (the sender's e-mail address) (act 40), the “reply to” address of the e-mail (act 50), any spoof potentials (act 60), links and images in the e-mail (act 70), age of the domain (act 80), whether the user had previously corresponded with the sender of the e-mail (act 90), and content of the e-mail (act 100). In some embodiments, spoof potentials may be evaluated based on whether a company from which an e-mail is purported to have been sent from has implement technologies to protect against someone spoofing their emails. These technologies may involve setting up records in DNS including, for example, SPF, DKIM, and DMARC.

The evaluations of these aspects are not mutually exclusive and may be performed in a different order than illustrated. In some embodiments some of these aspects are not evaluated, and in other embodiments alternative or additional aspects may be evaluated. In further embodiments the phishing security add-on may be customized by a user or system administrator to select which aspects and/or characteristics of an e-mail may be evaluated or to modify the significance of different aspects and/or characteristics, for example, to adjust the risk point scores assigned to different suspicious aspects and/or characteristics.

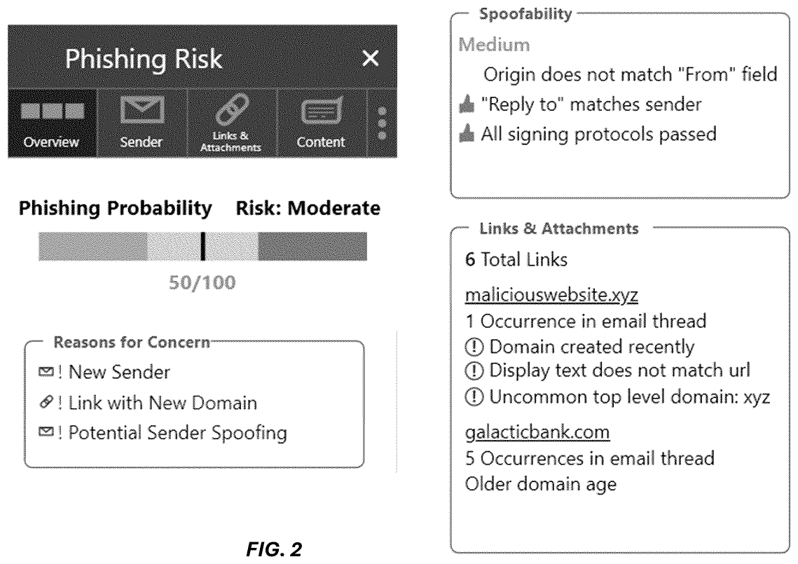

After each of the aspects of the e-mail are evaluated, the phishing security add-on adds all assigned risk point scores to determine an overall phishing risk point score that is correlated with an overall phishing risk level and phishing attack probability. The overall phishing risk level and phishing attack probability may be displayed to the user as a report in one or more windows such as illustrated in FIG. 2 (act 110) along with an indication of which aspects of the e-mail were concerning or suspicious. In the example of FIG. 2, the factors contributing to the “moderate” phishing risk level are indicated as including that the sender of the e-mail was new in the sense that there was no prior correspondence history between the user and the sender, the e-mail included a link with a recently created and unusual domain and with displayed text that did not match the actual url of the link, and that there was an indication that the sender's e-mail may have been spoofed. The indication of phishing attack probability may be indicated as a percentage value and may be graphically indicated on a bar chart as illustrated in FIG. 2. The phishing risk may be assigned a value of “high”, “moderate”, or “low” or may be given a numerical value of, for example, from 1 to 5 or from 1 to 100.

Responsive to reviewing the phishing evaluation report, the user may take various actions. If the user believes that the sender is legitimate and someone they had expected to receive an e-mail from they may mark the sender as trusted in a window of the phishing security add-on. Alternatively if the user believes that the sender is not legitimate and is not someone they had expected to receive an e-mail from they may mark the sender as untrusted in a window of the phishing security add-on (act 120). Similarly, the user can mark the domain of the e-mail as trusted or not depending on whether they are familiar with it or expected to receive an e-mail from a user at the domain of the e-mail (act 130). If the user believes that the e-mail is genuinely a phishing attack they may mark it as junk or spam (act 140) or take other actions such as reporting it to their system administrator and/or may select another e-mail to evaluate for phishing risk if desired (act 150).

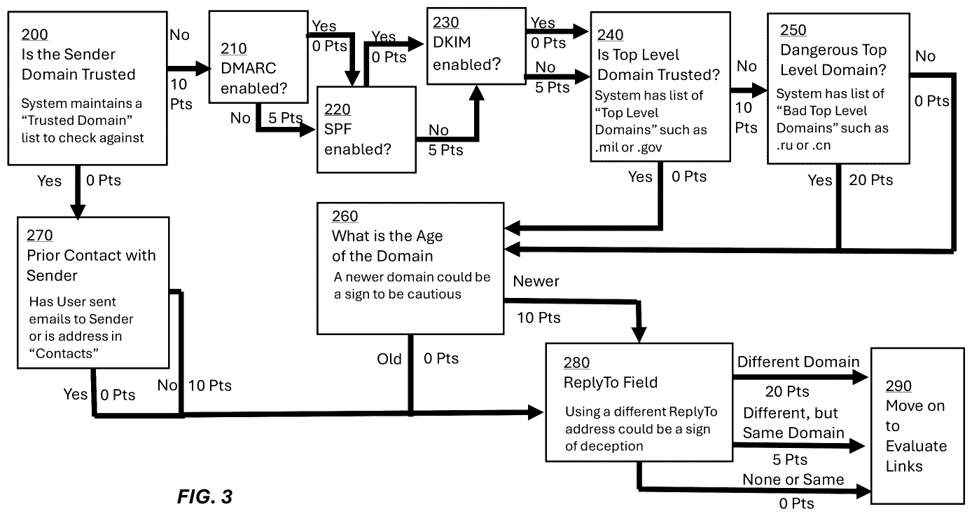

A flow chart of examples of characteristics related to the source of an e-mail that embodiments of the phishing security add-on system (also referred to herein as the phishing security add-on platform) may evaluate and example point scores associated with these characteristics are indicated in the flowchart of FIG. 3. In act 200 the phishing security add-on checks if the domain of the sender of an e-mail is trusted. The phishing security add-on system may maintain a list of trusted domain names within its memory to check against in this act. If the domain of the sender of the e-mail is not trusted, the system may add, for example, 10 risk points to the running risk point sum for the e-mail. If the domain of the sender of the e-mail is not trusted the phishing security add-on system may then check if the sender's domain is DMARC enabled (act 210). If the domain is DMARC enabled, no risk points are assigned. If the domain is not DMARC enabled 5 risk points may be added to the running risk point sum for the e-mail. The phishing security add-on system then proceeds to check if the sender's domain is SPF enabled (act 220). If the domain is SPF enabled, no risk points are assigned. If the domain is not SPF enabled 5 risk points may be added to the running risk point sum for the e-mail. The phishing security add-on system then proceeds to check if the sender's domain is DKIM enabled (act 230). If the domain is DKIM enabled, no risk points are assigned. If the domain is not DKIM enabled 5 risk points may be added to the running risk point sum for the e-mail.

The phishing security add-on system checks if the e-mail sender's top level domain is trusted (act 240). The phishing security add-on system may include a list of trusted top level domains, for example, .mil, .gov, etc. in its memory to check against in this act. If the e-mail sender's top level domain is trusted no risk points are added. If the e-mail sender's top level domain is not trusted 10 points may be added to the running risk point sum for the e-mail. The phishing security add-on system also checks if the e-mail sender's top level domain is mistrusted or “dangerous” (act 250). The phishing security add-on system may include a list of “dangerous” top level domains in its memory that are known for hosting users that generate phishing e-mails, for example, .ru, .cn, etc. to check against in this act. If the e-mail sender's top level domain is not considered dangerous no risk points are added. If the e-mail sender's top level domain is considered dangerous 20 points may be added to the running risk point sum for the e-mail.

The phishing security add-on system may check the age of the e-mail sender's domain, for example, using one of the existing domain age checking tools available online (act 260). A newer domain may be considered riskier than an older domain because the newer domain may have been created for the purpose of launching phishing attacks by malicious agents. If the domain is old, for example, greater than one year old or greater than three years old, no risk points are added. If the domain is new, for example, younger than 6 months 10 points may be added to the running risk point sum for the e-mail. The age threshold at which a domain is considered old or new may be configurable by a user or system administrator. In some embodiments instead of making a binary decision that a domain is old or new, a sliding scale may be utilized in which a number of points added to the running risk point sum for the e-mail may increase from 0 for domains older than a first threshold age to 10 for domains younger than a second threshold age, while an intermediate number of risk points may be added to domains with ages between the first and second threshold ages.

The phishing security add-on system may check whether the user has had prior contact with the sender of an e-mail (act 270), for example, whether the user has previously sent e-mails to the sender or if the sender is in the user's e-mail “Contacts” list. If the user has had prior contact with the sender of the e-mail no risk points are added to the risk point total for the e-mail. If the user has not had prior contact with the sender of the e-mail 10 risk points may be added to the risk point total for the e-mail.

The phishing security add-on system may evaluate the “ReplyTo” field of an e-mail (act 280). If the ReplyTo e-mail address is different than the e-mail address of the sender of the e-mail, this may be a sign of deception. If there is no e-mail address listed in the ReplyTo field of the e-mail or if the ReplyTo e-mail address matches that of the sender of the e-mail, no risk points may be added to the risk point total for the e-mail. If the ReplyTo e-mail address differs from that of the sender of the e-mail but has the same domain as the sender's e-mail address 5 risk points may be added to the risk point total for the e-mail. If the ReplyTo e-mail address differs from that of the sender of the e-mail and has a different domain than the sender's e-mail address 10 risk points may be added to the risk point total for the e-mail.

After all domain characteristic checks are completed, the phishing security add-on system may proceed to evaluating other aspects of the e-mail, for example, links that may be included in the e-mail (act 290).

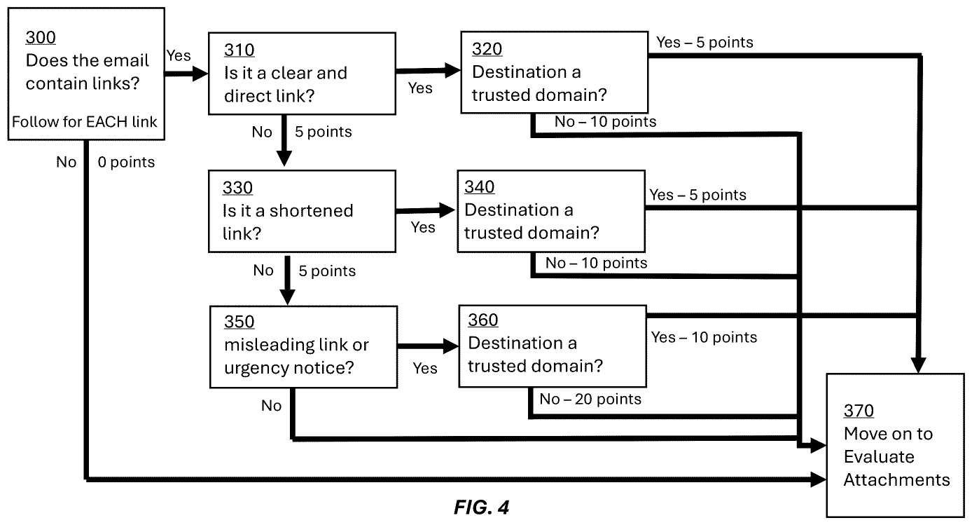

A flow chart of examples of characteristics related to links that may be included in an e-mail that embodiments of the phishing security add-on system may evaluate and example point scores associated with these characteristics are indicated in the flowchart of FIG. 4. At act 300 the phishing security add-on system determines if the e-mail contains any links. If there are no links in the e-mail the system moves on to evaluate another aspect of the e-mail, for example, attachments (act 370). If the e-mail contains at least one link the phishing security add-on system evaluates several characteristics of each of the links. The phishing security add-on system may evaluate whether a link is clear and direct (act 310), for example, if the actual hypertext of the link is the same as or is different from the text of the link displayed in the-email or if the link directs a user to a website that they would expect based on the context of the email. If the link is clear and direct, the system checks if the destination of the link is within a trusted domain (act 320). The phishing security add-on may maintain a list of trusted domain names within its memory to check against in this act and in other acts in which a domain of an aspect of the e-mail is evaluated. If the domain of the link destination is trusted 5 risk points may be added to the risk point total for the e-mail because while the link is likely safe, there is a small potential for a hacker to use various attacks such as a Cross Site Scripting (XSS Attack) that leverages a flaw in an innocent website. The system may move on to evaluate another aspect of the e-mail, for example, attachments (act 370). If the domain of the link destination is not trusted 10 risk points may be added to the risk point total for the e-mail and the system may move on to evaluate another aspect of the e-mail (act 370). If the link is not clear and direct 5 risk points may be added to the risk point total for the e-mail and the phishing security add-on system may evaluate whether the link is a shortened link (act 330). If the link is a shortened link, the system checks if the destination of the link is within a trusted domain (act 340). If the domain of the link destination is trusted 5 risk points may be added to the risk point total for the e-mail and the system may move on to evaluate another aspect of the e-mail (act 370). If the domain of the link destination is not trusted 10 risk points may be added to the risk point total for the e-mail and the system may move on to evaluate another aspect of the e-mail (act 370). If the link is not a shortened link 5 risk points may be added to the risk point total for the e-mail and the phishing security add-on system may evaluate whether the link appears misleading or includes an urgency notice (act 350). If so, the system checks if the destination of the link is within a trusted domain (act 340). If the domain of the link destination is trusted 5 risk points may be added to the risk point total for the e-mail and the system may move on to evaluate another aspect of the e-mail (act 370). If the domain of the link destination is not trusted 10 risk points may be added to the risk point total for the e-mail and the system may move on to evaluate another aspect of the e-mail (act 370). If the link does not appear misleading and does not include an urgency notice the system may move on to evaluate another aspect of the e-mail (act 370).

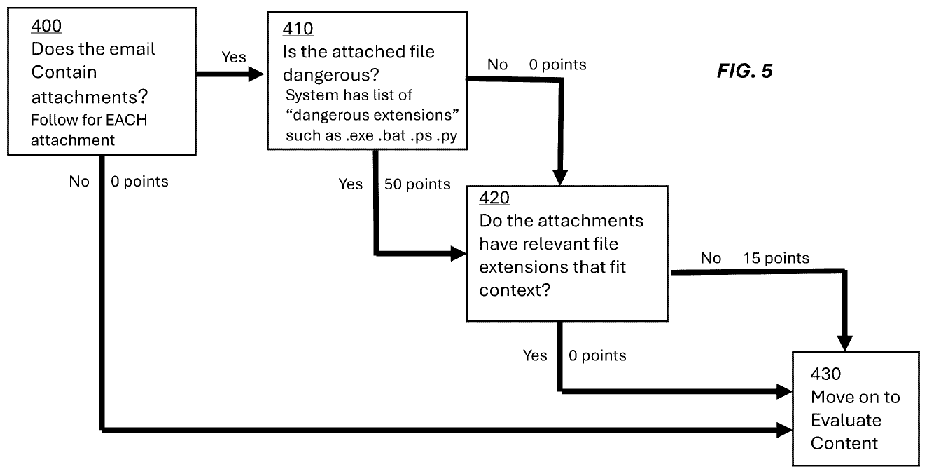

A flow chart of examples of characteristics related to the attachments that may be included in an e-mail that embodiments of the phishing security add-on system may evaluate and example point scores associated with these characteristics are indicated in the flowchart of FIG. 5. At act 400 the phishing security add-on system determines if the e-mail contains any attachments. If there are no attachments in the e-mail the system moves on to evaluate another aspect of the e-mail, for example, content of the e-mail (act 430). If the e-mail contains at least one attachment the phishing security add-on system evaluates several characteristics of each of the attachments. The phishing security add-on system may evaluate whether a file attachment may be considered risky or dangerous (act 410). For example, if an attachment is an executable file, it may be considered risky to open. The phishing security add-on system may include a list of file extensions within its memory that may be considered risky or dangerous that may be compared against the file extension of an attachment. Such file extensions may include, for example, .exe, .bat, .ps, .py, etc. If an attachment appears risky or dangerous 50 risk points may be added to the risk point total for the e-mail, otherwise no risk points are added to the risk point total for the e-mail responsive to this evaluation. The phishing security add-on system may evaluate whether a file attachment has a file extension that fits the context of the attachment (act 420). If, for example, a file extension purports to be an image, one would expect it to have a file extension of .jpg, .bmp, or another extension consistent with an image file. If the alleged image file has an extension inconsistent with it being an image file, for example, a file extension consistent with an executable file, this may be indicative of a potentially dangerous file attachment. If an attachment has a file extension that does not fit the context of the attachment 15 risk points may be added to the risk point total for the e-mail, otherwise no risk points are added to the risk point total for the e-mail responsive to this evaluation. After the evaluations of the characteristics of each file attachment are completed, the system moves on to evaluate another aspect of the e-mail, for example, content of the e-mail (act 430).

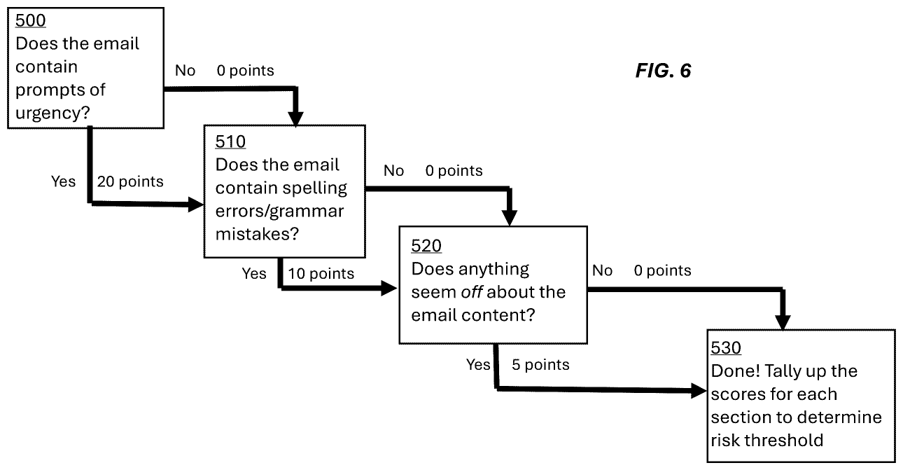

A flow chart of examples of characteristics related to content of an e-mail that embodiments of the phishing security add-on system may evaluate and example point scores associated with these characteristics are indicated in the flowchart of FIG. 6. The phishing security add-on system may evaluate whether an e-mail includes prompts of urgency (act 500). Sometimes when people think that they have to act urgently they do not take the time to give sufficient thought to possible risks of their actions and may click on a malicious link or take another action with respect to an allegedly urgent matter conveyed to them in a phishing attack e-mail. In some embodiments, the phishing security add-on system may maintain a list of words or phrases within its memory that are often used to convey a sense of urgency. Such phases may include, for example, “Urgent!” “Immediate Response Required!,” etc. that the system can compare against phrases within an e-mail being evaluated. Additionally or alternatively, the phishing security add-on system may prompt a user to indicate whether the e-mail includes prompts of urgency. If the e-mail includes one or more prompts of urgency 20 risk points may be added to the risk point total for the e-mail, otherwise no risk points are added to the risk point total for the e-mail responsive to this evaluation. The phishing security add-on system may evaluate whether an e-mail includes spelling errors or grammar mistakes (act 510). In many instances phishing attacks originate in countries or organizations having people who are not fluent in English. An e-mail including spelling errors or grammar mistakes may thus be indicative of a potential phishing attack e-mail. Similarly, if the name of the recipient of the e-mail is incorrectly spelled or simply incorrect, or if the e-mail includes a generic greeting rather than a greeting including the recipient's name, this may be a sign of a potential phishing attack e-mail. In some embodiments, the phishing security add-on system may include a spelling and/or grammar check module to analyze e-mails for spelling and grammar errors. If the e-mail includes one or more spelling or grammar errors 10 risk points may be added to the risk point total for the e-mail, otherwise no risk points are added to the risk point total for the e-mail responsive to this evaluation. The phishing security add-on system may evaluate whether an e-mail includes anything that looks suspicious or “off” (act 530). For example, if an e-mail refers to an account at a financial institution that the recipient does not have an account with, a warning or recall regarding a product the recipient does not possess, or requests personal information that the sender of the e-mail would be unlikely to request, this may be a sign of a potential phishing attack e-mail. If the e-mail appears suspicious or somehow “off” 5 risk points may be added to the risk point total for the e-mail, otherwise no risk points are added to the risk point total for the e-mail responsive to this evaluation.

Responsive to completing the evaluation of characteristics of the e-mail content, as well as the evaluations of the other aspects of an e-mail discussed above, the risk point total for the e-mail may be totaled and the phishing probability and risk as well as factors contributing to same displayed to the user, for example, in a display such as shown in FIG. 2 above.

It is to be appreciated that the evaluation of the aspects of an e-mail described with respect to FIGS. 3-6, or any other aspects of an e-mail may be performed in any order, and not necessarily that indicated in FIGS. 3-6.

Various aspects and functions described herein in accordance with the present embodiments may be implemented as hardware or software on one or more computer systems. There are many examples of computer systems currently in use. These examples include, among others, network appliances, personal computers, workstations, mainframes, networked clients, servers, media servers, application servers, database servers, and web servers. Other examples of computer systems may include mobile computing devices, such as cellular phones and personal digital assistants, and network equipment, such as load balancers, routers and switches. Further, aspects in accordance with the present embodiments may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the embodiments are not limited to executing on any particular system or group of systems. Further, aspects may be implemented in software, hardware or firmware, or any combination thereof. Thus, aspects in accordance with the present embodiments may be implemented within methods, acts, systems, system elements and components using a variety of hardware and software configurations, and the embodiments are not limited to any particular distributed architecture, network, or communication protocol.

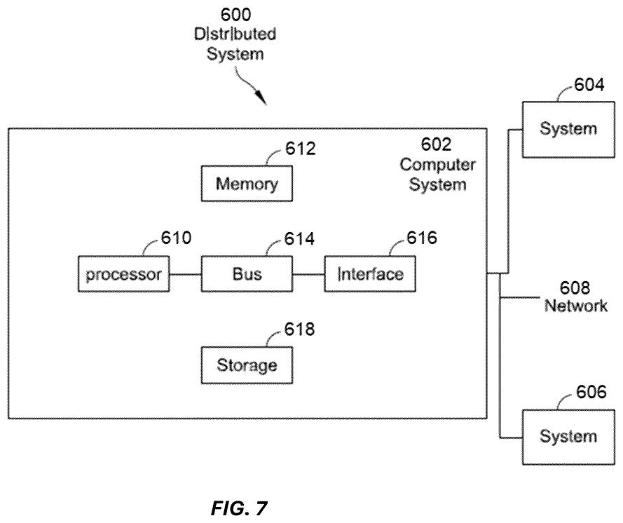

FIG. 7 shows a block diagram of a distributed computer system 600, in which various aspects and functions in accord with the present embodiments may be practiced. Distributed computer system 600 may include one more computer systems. For example, as illustrated, distributed computer system 600 includes computer systems 602, 604, and 606. One of computer systems 602, 604, 606 may be a server hosting a website that may be accessed by others of the computer systems 602, 604, 606 by users to access embodiments of the phishing security add-on system disclosed here. As shown, computer systems 602, 604, and 606 are interconnected by, and may exchange data through, communication network 608. Network 608 may include any communication network through which computer systems may exchange data. To exchange data using network 608, computer systems 602, 604, and 606 and network 608 may use various methods, protocols and standards, including, among others, Ethernet, TCP/IP, SMS, and Json. To ensure data transfer is secure, computer systems 602, 604, and 606 may transmit data via network 608 using a variety of security measures including TLS, SSL, or VPN among other security techniques. While distributed computer system 600 illustrates three networked computer systems, distributed computer system 600 may include any number of computer systems and computing devices, networked using any medium and communication protocol.

Various aspects and functions in accordance with the present embodiments may be implemented as specialized hardware or software executing in one or more computer systems including computer system 602 shown in FIG. 7. As depicted, computer system 602 includes processor 610, memory 612, bus 614, interface 616, and storage 618. Processor 610 may perform a series of instructions that result in manipulated data. Processor 610 may be a commercially available processor such as an Intel Core®, Motorola PowerPC, SGI MIPS, Sun UltraSPARC, or Hewlett-Packard PA-RISC processor, but may be any type of processor, multi-processor, microprocessor, or controller as many other processors and controllers are available. Processor 610 is connected to other system elements, including one or more memory devices 612, by bus 614.

Memory 612 may be used for storing programs and data during operation of computer system 602. Thus, memory 612 may be a relatively high performance, volatile, random-access memory such as a dynamic random-access memory (DRAM) or static memory (SRAM). However, memory 612 may include any device for storing data, such as a disk drive or other non-volatile, non-transitory, storage device. Various embodiments may organize memory 612 into particularized and, in some cases, unique structures to perform the aspects and functions disclosed herein.

Components of computer system 602 may be coupled by an interconnection element such as bus 614. Bus 614 may include one or more physical busses, for example, busses between components that are integrated within a same machine, but may include any communication coupling between system elements including specialized or standard computing bus technologies such as IDE, SCSI, PCI, and InfiniBand. Thus, bus 614 enables communications, for example, data and instructions, to be exchanged between system components of computer system 602.

Computer system 602 also includes one or more interface devices 616 such as input devices, output devices, and combination input/output devices. Interface devices may receive input or provide output. More particularly, output devices may render information for external presentation. The interface devices 616 may include, for example, one or more graphical user interfaces that may be disposed proximate to or separate from other components of the computer system 602. A graphical user interface of the computer system 602 may, for example, be displayed through a web browser that accesses information from the memory 612. Input devices may accept information from external sources. Examples of interface devices include keyboards, mouse devices, trackballs, microphones, touch screens, printing devices, display screens, speakers, network interface cards, etc. Interface devices allow computer system 602 to exchange information and communicate with external entities, such as users and other systems.

Storage system 618 may include a computer readable and writeable, nonvolatile, non-transitory, storage medium in which instructions are stored that define a program to be executed by the processor. The program to be executed by the processor may cause the processor 600 or computer system 602 to perform any one or more embodiments of the methods disclosed herein. Storage system 618 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. The medium may, for example, be optical disk, magnetic disk, or flash memory, among others. In operation, the processor or some other controller may cause data to be read from the nonvolatile recording medium into another memory, such as memory 612, that allows for faster access to the information by the processor than does the storage medium included in storage system 618. The memory may be located in storage system 618 or in memory 612, however, processor 610 may manipulate the data within the memory 612, and then may copy the data to the medium associated with storage system 618 after processing is completed. A variety of components may manage data movement between the medium and integrated circuit memory element and the presently described embodiments are not limited thereto. Further, the embodiments are not limited to a particular memory system or data storage system. Portions of the memory 612 or storage system 618 may be included in the same computer system as other components of the computer system 602 or may be resident in a cloud-based system that is accessible via the internet or other communications system or protocol.

Although computer system 602 is shown by way of example as one type of computer system upon which various aspects and functions in accordance with the present embodiments may be practiced, any aspects of the presently disclosed embodiments are not limited to being implemented on the computer system as shown in FIG. 7. Various aspects and functions in accordance with the presently disclosed embodiments may be practiced on one or more computers having a different architectures or components than that shown in FIG. 7. For instance, computer system 602 may include specially-programmed, special-purpose hardware, for example, an application-specific integrated circuit (ASIC) tailored to perform a particular operation disclosed herein. Another embodiment may perform the same function using several general-purpose computing devices running MAC OS System X with Motorola PowerPC processors and several specialized computing devices running proprietary hardware and operating systems.

Computer system 602 may be a computer system including an operating system that manages at least a portion of the hardware elements included in computer system 602. Usually, a processor or controller, such as processor 610, executes an operating system which may be, for example, a Windows-based operating system such as Windows 11 or Windows 10 operating systems, available from the Microsoft Corporation, a MAC OS System X operating system available from Apple Computer, one of many Linux-based operating system distributions, for example, the Enterprise Linux operating system available from Red Hat Inc., a Solaris operating system available from Sun Microsystems, or a UNIX operating system available from various sources. Many other operating systems may be used, and embodiments are not limited to any particular implementation.

The processor and operating system together define a computer platform for which application programs in high-level programming languages may be written. These component applications may be executable, intermediate, for example, C−, bytecode or interpreted code which communicates over a communication network, for example, the Internet, using a communication protocol, for example, TCP/IP. Similarly, aspects in accord with the presently disclosed embodiments may be implemented using an object-oriented programming language, such as . Net, SmallTalk, Java, C++, Ada, or C # (C-Sharp). Other object-oriented programming languages may also be used. Alternatively, functional, scripting, or logical programming languages may be used.

Additionally, various aspects and functions in accordance with the presently disclosed embodiments may be implemented in a non-programmed environment, for example, documents created in HTML, XML, or other format that, when viewed in a window of a browser program, render aspects of a graphical-user interface or perform other functions. Further, various embodiments in accord with the present invention may be implemented as programmed or non-programmed elements, or any combination thereof. For example, a web page may be implemented using HTML while a data object called from within the web page may be written in C++. Thus, the presently disclosed embodiments are not limited to a specific programming language and any suitable programming language could also be used.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A computerized platform for providing a user with an indication of one of a risk level or a probability of an e-mail including a phishing attack, the computerized platform configured to perform a method comprising:
performing an assessment of one or more characteristics of one or more aspects of the e-mail;
determining the one of the risk level or the probability of the e-mail including a phishing attack based on results of the assessment; and
providing the user with the indication of the one of the risk level or the probability of the e-mail including the phishing attack.

2. The computerized platform of claim 1, wherein the computerized platform is configured to produce a graphical display including the indication of the one of the risk level or the probability of the e-mail including the phishing attack.

3. The computerized platform of claim 2, wherein the computerized platform is further configured to provide an indication of one or more factors contributing to the one of the risk level or the probability of the e-mail including the phishing attack within the graphical display.

4. The computerized platform of claim 1, wherein the one or more aspects include one or more of a source of the e-mail, spoof potential of the e-mail, a link within the e-mail, an attachment to the e-mail, or content of the e-mail.

5. The computerized platform of claim 4, wherein the one or more characteristics of the source of the e-mail include one or more of whether a domain of the source of the e-mail is trusted, whether the domain of the source of the e-mail is DMARC, SPF, or DKIM enabled, whether a top level domain of the source of the e-mail is trusted, whether the top level domain of the source of the e-mail is dangerous, or an age of the domain of the source of the e-mail.

6. The computerized platform of claim 4, wherein the one or more characteristics of the source of the e-mail include whether the user has had prior contact with the source of the e-mail.

7. The computerized platform of claim 4, wherein the one or more characteristics of the source of the e-mail include whether a Reply To address of the email matches the source of the e-mail.

8. The computerized platform of claim 4, wherein the one or more characteristics of the link within the e-mail include one or more of whether the link is clear and direct, whether the link is a shortened link, or whether the link is misleading.

9. The computerized platform of claim 4, wherein the one or more characteristics of the attachment to the e-mail include one or more of whether a file extension of the attachment is considered dangerous or whether the attachment has a file extension that is consistent with its context.

10. The computerized platform of claim 4, wherein the one or more characteristics of the content of the e-mail include one or more of whether the e-mail includes a prompt of urgency, whether the e-mail includes spelling or grammar mistakes, or whether the e-mail appears suspicious to the user.

11. A method for providing a user with an indication of one of a risk level or a probability of an e-mail including a phishing attack, the method comprising:
performing an assessment of one or more characteristics of one or more aspects of the e-mail;
determining the one of the risk level or the probability of an e-mail including a phishing attack based on results of the assessment; and
providing the user with the indication of the one of the risk level or the probability of the e-mail including the phishing attack.

12. The method of claim 11, further comprising producing a graphical display including the indication of the one of the risk level or the probability of the e-mail including the phishing attack.

13. The method of claim 12, further comprising providing an indication of one or more factors contributing to the one of the risk level or the probability of the e-mail including the phishing attack within the graphical display.

14. The method of claim 11, wherein the one or more aspects include one or more of a source of the e-mail, spoof potential of the e-mail, a link within the e-mail, an attachment to the e-mail, or content of the e-mail.

15. The method of claim 14, wherein the one or more characteristics of the source of the e-mail include one or more of whether a domain of the source of the e-mail is trusted, whether the domain of the source of the e-mail is DMARC, SPF, or DKIM enabled, whether a top level domain of the source of the e-mail is trusted, whether the top level domain of the source of the e-mail is dangerous, or an age of the domain of the source of the e-mail.

16. The method of claim 14, wherein the one or more characteristics of the source of the e-mail include whether the user has had prior contact with the source of the e-mail.

17. The method of claim 14, wherein the one or more characteristics of the source of the e-mail include whether a Reply To address of the email matches the source of the e-mail.

18. The method of claim 14, wherein the one or more characteristics of the link within the e-mail include one or more of whether the link is clear and direct, whether the link is a shortened link, or whether the link is misleading.

19. The method of claim 14, wherein the one or more characteristics of the attachment to the e-mail include one or more of whether a file extension of the attachment is considered dangerous or whether the attachment has a file extension that is consistent with its context.

20. The method of claim 14, wherein the one or more characteristics of the content of the e-mail include one or more of whether the e-mail includes a prompt of urgency, whether the e-mail includes spelling or grammar mistakes, or whether the e-mail appears suspicious to the user.

21. A non-transitory computer readable medium having instructions encoded thereon which when executed by a processing system of computer causes the processing system to perform a for providing a user with an indication of one of a risk level or a probability of an e-mail including a phishing attack, the method comprising:
performing an assessment of one or more characteristics of one or more aspects of the e-mail;
determining the one of the risk level or the probability of an e-mail including a phishing attack based on results of the assessment; and
providing the user with the indication of the one of the risk level or the probability of the e-mail including the phishing attack.
